(19) United States
(12) Patent Application Publication
(10) Pub. No.: US 2012/0124427 A1
(43) Pub. Date: May 17, 2012

(54) METHOD AND DEVICE FOR ERROR CONTROL IN AN OVERALL SYSTEM HAVING MULTIPLE INSTALLATIONS

(76) Inventor: Karsten Haug, Stuttgart (DE)

(21) Appl. No.: 13/319,942

(22) PCT Filed: May 27, 2010
(86) PCT No.: PCT/EP10/57361

§ 371 Date: Jan. 27, 2012

(30) Foreign Application Priority Data
Jun. 8, 2009 (DE) 10 2009 026 807.3

(51) Int. Cl. G06F 11/28

(52) U.S. Cl. 714/40; 714/E11.178

(57) ABSTRACT

A method for error control in an overall system having multiple installations, the installations communicating with one another via a data transmission system having a predefined transmission bandwidth, at least one installation component of each installation transmitting a predefined piece of information in a defined time slot of the transmission bandwidth of the data transmission system. In order to be able to perform an anticipatory machine diagnosis of the overall system, information concerning an error diagnosis of the installation components of each installation is transmitted via the predefined transmission bandwidth of the data transmission system, at least one installation component of each installation to be monitored for errors transmitting its error diagnosis data via an unassigned time slot within the transmission bandwidth of the data transmission system to a central evaluation unit which receives the error diagnosis data of all installation components of the installations to be monitored via the data transmission system.

### FIELD OF THE INVENTION

The present invention relates to a method for error control in an overall system having multiple installations, the installations communicating with one another via a data transmission system having a predefined transmission bandwidth, at least one installation component of each installation transmitting a predefined piece of information in a defined time slot of the transmission bandwidth or according to a defined arbitration method of the data transmission system as well as a device for executing the method.

### BACKGROUND INFORMATION

For the purpose of error diagnosis in a machine or installation when a defective function of a machine or installation component is presumed, an external diagnostic unit is today usually connected to this installation component. In the case of this diagnostic unit, a sensor measures separate physical variables which are forwarded to a measurement computer where they are evaluated. The result of this selective use of error control is that only an installation component is serviced that has already appeared to be defective. Other installation or machine components continue to operate until the presence of an error is suspected in them as well.

This approach increases the probability of an unexpected failure of the installation component, if not of the entire machine or installation, resulting in undesirable shutdown and repair times, which may seriously disrupt the normal workflow of an overall system to which the machine or installation is assigned.

### SUMMARY

An example method according to the present invention for error control of an overall system having multiple installations may have an advantage that it is possible to perform a preventive diagnosis of the overall system. It is possible to monitor and evaluate a plurality of machine states due to the fact that information concerning an error diagnosis of the installation components of each installation is transmitted via the predefined transmission bandwidth of the data transmission system, at least one installation component of each installation to be monitored for errors sending its error diagnosis data via an unassigned time slot in the transmission bandwidth of the data transmission system to a central evaluation unit which receives the error diagnosis data of all installation components of the installations to be monitored. The use of open time slots in the bandwidth of the data transmission system makes it possible to evaluate both physical variables such as currents and voltages as well as sequence times such as, for example, the movement of certain mechanical actuators of the overall system. From this it is possible to derive a trend in a simple manner as to which installation components are interference-prone and possibly already initiate a spare parts order. This early detection of an error shortens maintenance intervals.

Advantageously, the unassigned time slot in the bandwidth of the data transmission system is determined with the error diagnosis switched off. The open time slot is determined reliably during the normal operating state of the overall system in which the installations perform the functions assigned to them in order to obtain precise information concerning the regularly available unassigned bandwidth of the data transmission system.

In one embodiment, the unassigned time slot of the installations of the overall system which are in the operating state is determined as a function of whether the installation components of the installations of the overall system operate in normal operation, without fluctuation or a predefined number of fluctuations occur in a defined unit of time in the overall system or fluctuations occur in all installation components of the installations of the overall system. These fluctuations during the normal operation of the installations may have different causes, such as fluctuations in the physical events, e.g., in the movement of pneumatic cylinders. However, the fluctuations are also influenced by the number of defective parts of the installation components, since the defective parts are treated differently than correctly manufactured and working parts. Such fluctuations of the installations ensure that the bandwidth of the unassigned time slot fluctuates.

From the three different operating states, it is possible to use a weighted averaging method to ascertain an average unassigned time slot, which provides the basis for the exchange of error diagnosis signals during the operation of the overall system for a reliable preventive system diagnosis.

In one refinement, the data transmissions within the predefined bandwidth of the data transmission system are monitored and evaluated during the operating state of the installation components of the installations of the overall system for detecting the unassigned time slot. This approach is used to determine the open time slot without an additional expenditure of time during the normal operation of the overall system.

Advantageously, the installation components of the installations to be monitored for errors are prioritized in a sequence in a configuration phase, this sequence being considered in the assignment of the unassigned time slot in the bandwidth of the data transmission system. The advantage of this is that it is established in advance which installation components are of particular importance, so that the error diagnosis signals of these installation components are transmitted to the evaluation unit reliably even in the case of fluctuations in the bandwidth within the unassigned time slot during the normal operation of the overall system.

In one embodiment, error diagnosis signals are selected in the configuration phase for each installation component to be monitored, each error diagnosis signal being assigned to a diagnosis bandwidth within the unassigned time slot of the transmission bandwidth of the data transmission system. In the case of fluctuations of the unassigned time slot during the operation of the overall system, this determination of the bandwidth of the unassigned time slot makes it possible to quickly select the error diagnosis signals for transmission to the evaluation unit, which fit into the currently occurring unassigned time slot of the transmission bandwidth of the data transmission system due to the diagnosis bandwidth assigned to them.

In one refinement, if an increased need exists for defined time slots in the transmission bandwidth of the data transmission system during the operating state of the overall system, the transmission of the error diagnosis signals of such installation components which were classified at a lower priority in the sequence of the installation components is suppressed.

Advantageously, the prioritized error diagnosis signals of each installation component are reduced step-wise according to their prioritization, starting with error diagnosis signals of the lowest priority, if an increased need exists for defined time slots in the transmission bandwidth of the data transmission system during the operating state of the overall system.

The two-dimensional prioritization strategy (prioritization of the installation components and prioritization of the error diagnosis signals) adopted in advance makes it possible to adapt the selection of the error diagnosis signals to be transmitted easily and rapidly to the predefined limits present in the overall system in the operating case.

Another refinement of the present invention relates to a device for error control in an overall system having multiple installations, the installations communicating with one another via a data transmission system having a predefined transmission bandwidth, at least one installation component of each installation transmitting a predefined piece of information in a defined time slot of the transmission bandwidth of the data transmission system. In order to be able to perform an anticipatory machine diagnosis of the overall system, the data transmission system is connected to the installation components of each installation and a central evaluation unit and transmits information to them concerning an error diagnosis of the installation components of each installation within the predefined transmission bandwidth, at least one installation component of each installation to be monitored for errors transmitting its error diagnosis data via an unassigned time slot within the transmission bandwidth of the data transmission system to the central evaluation unit which receives the error diagnosis data of all installation components of the installations to be monitored via the data transmission system. An advantage of example embodiments of the present invention is that all diagnostic data of the overall system are combined in the evaluation unit, thus making it possible to discover and prevent possible errors very early. The use of only one diagnosis computer for all installation components of the installations of the overall system significantly reduces the costs for such a preventive measure.

In one embodiment, the data transmission system is designed as a field bus. Such a field bus connects all sensors, actuators and drives of an installation to the evaluation unit. To this end, the signals to be transmitted are sent with high reliability and rapid availability.

Advantageously, the field bus links the installation components of the installations in a cabled data network, which makes the control and monitoring of production processes simple. Radio transmission is also possible.

### BRIEF DESCRIPTION OF THE DRAWINGS

The present invention allows numerous specific embodiments. One of them is explained below in greater detail with reference to the figures.

FIG. 1 shows a schematic diagram of a production system according to an example device according to the present invention.

FIG. 2 shows a schematic flow chart of an error diagnosis in a production system according to FIG. 1.

FIG. 2a shows a configuration phase.

FIG. 2b shows an implementation phase.

### DETAILED DESCRIPTION OF EXAMPLE EMBODIMENTS

Identical features are denoted by identical reference numerals.

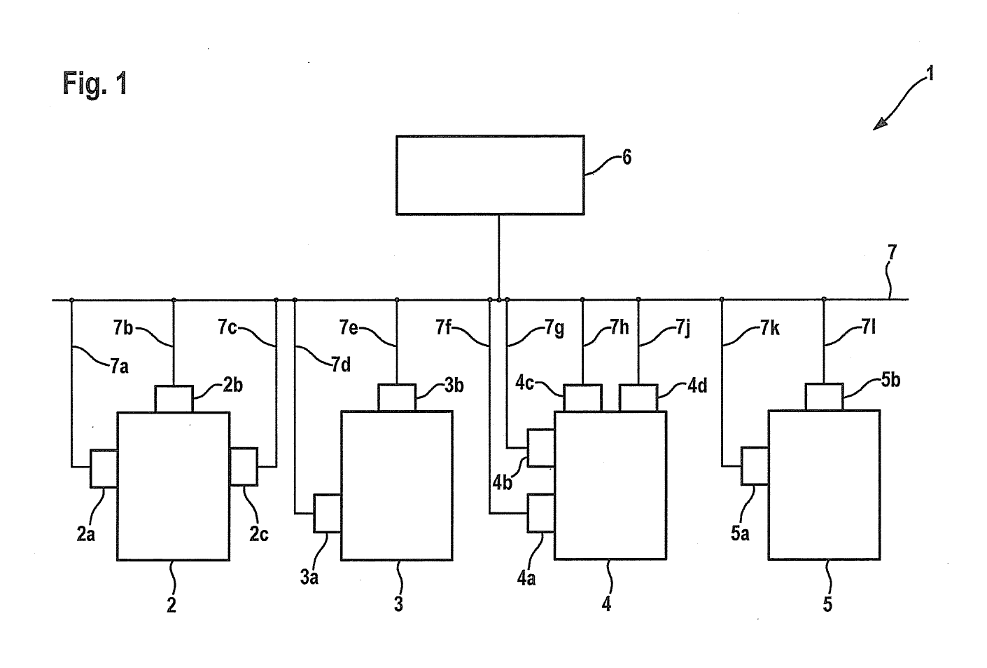

FIG. 1 shows a production system having a plurality of machines and installations. For the sake of clarity, the number of installations 2, 3, 4, 5 is limited to four in the present example. Each of these installations 2, 3, 4, 5 has a large number of components in the form of sensors, actuators and drives. The number varies from installation to installation. Thus, installation 2 has components 2a, 2b and 2c. Installation 3 has components 3a and 3b, while installation 4 has components 4a, 4b 4c and 4d. In contrast, installation 5 only has components 5a and 5b. The number of components is not limited to the number shown, but instead may exceed them by far.

Each of these components 2a, 2b, 2c, 3a, 3b, 4a, 4b, 4c, 4d, 5a, 5b represents a monitoring point which is to be monitored in a diagnostic system. For this purpose, each individual component 2a, 2b, 2c, 3a, 3b, 4a, 4b, 4c, 4d, 5a, 5b is connected to a single diagnostic computer 6 which collects and evaluates the error diagnosis signals of components 2a, 2b, 2c, 3a, 3b, 4a, 4b, 4c, 4d, 5a, 5b. Components 2a, 2b, 2c, 3a, 3b, 4a, 4b, 4c, 4d, 5a, 5b of installations 2, 3, 4, 5 are connected electronically to diagnostic computer 6 via a field bus 7 and are linked, for example, according to the Ethernet standard. For example, Prof met or Sercos are used as field bus 7, which operates using this Ethernet standard. Each component 2a, 2b, 2c, 3a, 3b, 4a, 4b, 4c, 4d, 5a, 5b is connected to field bus 7 via a lead 7a, 7b, 7c, 7d, 7e, 7f, 7g, 7h, 7j, 7k, 7l.

In the case of above-named field bus 7, the fixedly predefined transmission bandwidth is divided into fixed time slots, to which the transmitted functional data sent by one of components 2a, 2b, 2c, 3a, 3b, 4a, 4b, 4c, 4d, 5a, 5b during the production process are fixedly assigned (isochronic transfer). A residual time slot is provided for an asynchronous protocol. For the diagnostic monitoring of the production system, either an open isochronic slot or parts of the asynchronous slot are used.

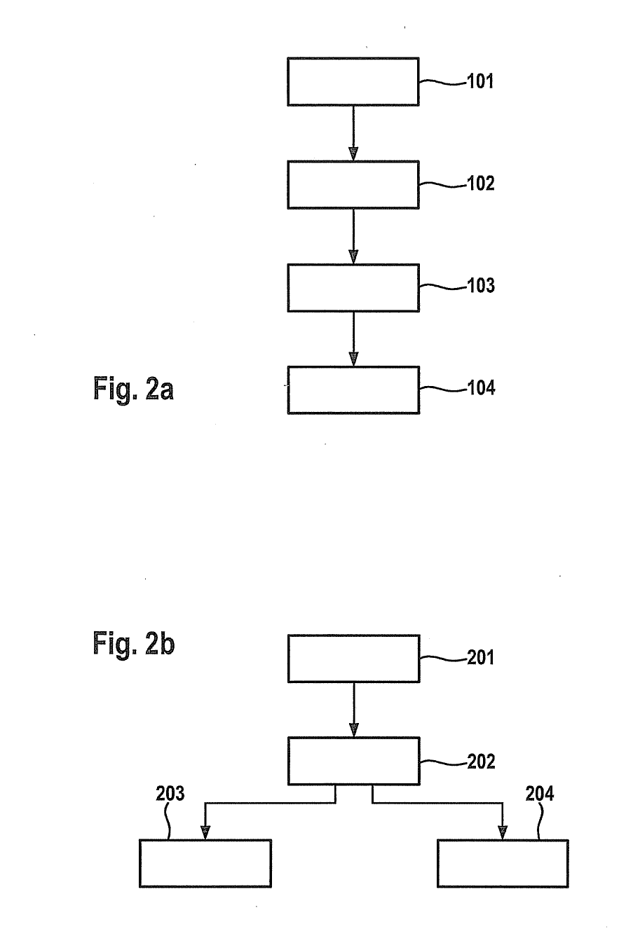

The utilization of this residual time slot for diagnostic purposes will be explained in greater detail with reference to FIG. 2.

The approach is broken down into a configuration phase, in which the open time slot of the bandwidth of field bus 7 is theoretically distributed to components 2a, 2b, 2c, 3a, 3b, 4a, 4b, 4c, 4d, 5a, 5b to be monitored, and into an implementation phase in which the error diagnosis signals to be transmitted during the production processes are adapted to the fluctuating open time slot of the bandwidth of field bus 7.

The configuration phase will be observed first with the aid of FIG. 2a. In block 101, production system 1 operates in normal operation. The diagnosis or error control is deactivated. Starting from this setting, the open time slot of the bandwidth of field bus 7 of production system 1 is determined in block 102. To this end, the amount of bus bandwidth needed by overall system 1 is established in different operating cases. In the first minimal operating case, it is assumed that production system 1 operates at a minimal bandwidth requirement. In a second case considered to be typical, it is assumed that, for example, a defective part emerges every 10 minutes, while in a third maximal operating case, defective parts emerge continuously in all installations 2, 3, 4, 5 of overall system 1. In the three explained cases, the data transfer on field bus 7 is monitored and evaluated over a longer period of time, the size of the open time slot being determined for each case. With the aid of weighted averaging an average open time slot is ascertained from the open time slots ascertained in the three observed operating cases.

In block 103, components 2a, 2b, 2c, 3a, 3b, 4a, 4b, 4c, 4d, 5a, 5b to be monitored are subjected to a prioritization. To this end, a sequence of components 2a, 2b, 2c, 3a, 3b, 4a, 4b, 4c, 4d, 5a, 5b is prepared based on their importance. A selection of the signals to be monitored which are to be subjected to the error diagnosis is made in block 104. For each component 2a, 2b, 2c, 3a, 3b, 4a, 4b, 4c, 4d, 5a, 5b, it is established in this block which signals are to be monitored at which bandwidth (i.e., word length and sampling rate). When the signals are selected, it may already be established if it is possible to monitor the signal within the available average open time slot of production system 1. This concludes the configuration phase.

In the implementation phase, which will be explained with the aid of FIG. 2b, production system 1 operates in normal operation in block 201 and the diagnosis and error control by central diagnostic computer 6 is active. In block 202, it is established which need for bandwidth of field bus 7 is required for the actual processing by installations 2, 3, 4, 5 and the open time slot available for the diagnosis is determined from this.

If it is established in block 202 that the open time slot of field bus 7 is not adequate for monitoring all components 2a, 2b, 2c, 3a, 3b, 4a, 4b, 4c, 4d, 5a, 5b and signals as provided for the first case in which it was assumed that no fluctuations occur, the monitoring of the data transmission by components 2a, 2b, 2c, 3a, 3b, 4a, 4b, 4c, 4d, 5a, 5b having a lower priority is stopped in block 203. To this end, the sequence of components 2a, 2b, 2c, 3a, 3b, 4a, 4b, 4c, 4d, 5a, 5b is reverted to as defined in the configuration phase.

Alternatively, a ranking of their signals based on required bandwidth is defined for each component 2a, 2b, 2c, 3a, 3b, 4a, 4b, 4c, 4d, 5a, 5b in block 204. Subsequently, the signals to be transmitted are blocked step-wise, so that the bandwidth required for the transfer of the error diagnosis signals is reduced.

Such a configuration of the bandwidth of field bus 7 makes it possible to distribute the open bandwidth of field bus 7 among components 2a, 2b, 2c, 3a, 3b, 4a, 4b, 4c, 4d, 5a, 5b to be monitored in a convenient manner even in complex installations. If the error patterns change, it is then possible to change priorities rapidly or record additional signals. It is also ensured that the existing bandwidth of field bus 7 is constantly utilized optimally.

1-11. (canceled)

12. A method for error control in an overall system having multiple installations, the installations communicating with one another via a data transmission system having a predefined transmission bandwidth, at least one installation component of each installation transmitting a predefined piece of information in a defined time slot of the transmission bandwidth of the data transmission system, the method comprising:
transmitting information concerning an error diagnosis of the installation components of each installation via the predefined transmission bandwidth of the data transmission system; and
transmitting, by at least one installation component of each of the installations to be monitored for errors, error diagnosis data via an unassigned time slot within the transmission bandwidth of the data transmission system, to a central evaluation unit which receives the error diagnosis data of all installation components of the installations to be monitored via the data transmission system.

13. The method as recited in claim 12, wherein the unassigned time slot in the transmission bandwidth of the data transmission system is determined with the error diagnosis switched off.

14. The method as recited in claim 13, wherein the unassigned time slot of the installations of the overall system which are in the operating state is determined as a function of whether the installation components of the installations of the overall system operate in normal operation one of without fluctuation, with a predefined number of fluctuations occurring in a defined unit of time in the overall system, or with fluctuations occurring in all installation components of the installations of the overall system.

15. The method as recited in claim 14, wherein the data transmissions within the predefined bandwidth of the data transmission system are monitored and evaluated during an operating state of the installation components of the installations of the overall system for detecting the unassigned time slot.

16. The method as recited in claim 12, wherein the installation components of the installations to be monitored for errors are prioritized in a sequence in a configuration phase, the sequence being considered in the assignment of the unassigned time slot in the bandwidth of the data transmission system.

17. The method as recited in claim 16, wherein error diagnosis signals are selected in the configuration phase for each installation component to be monitored, a diagnosis bandwidth within the unassigned time slot of the transmission bandwidth of the data transmission system being assigned to each error diagnosis signal.

18. The method as recited in claim 17, wherein the transmission of the error diagnosis signals of such installation components which were classified at a lower priority in the sequence of the installation components is suppressed if an increased need exists for defined time slots in the transmission bandwidth of the data transmission system during the operating state of the overall system.

19. The method as recited in claim 18, wherein the prioritized error diagnosis signals of each installation component are reduced step-wise according to prioritizations if an increased need exists for defined time slots in the transmission bandwidth of the data transmission system during the operating state of the overall system.

20. A device for error control in an overall system having multiple installations, the installations communicating with one another via a data transmission system having a predefined transmission bandwidth, at least one installation component of each installation transmitting a predefined piece of information in a defined time slot of the transmission bandwidth of the data transmission system, wherein the data transmission system is connected to the installation components of each installation, and transmits information concerning an error diagnosis of the installation components of each installation via a predefined transmission bandwidth, the device comprising:
a control evaluation unit, at least one installation component of each installation to be monitored for errors transmitting its error diagnosis data via an unassigned time slot within the transmission bandwidth of the data transmission system to the central evaluation unit, the central evaluation unit configured to receive the error diagnosis data of all installation components of the installations to be monitored via the data transmission system.

21. The device as recited in claim 20, wherein the data transmission system is a field bus.

22. The device as recited in claim 21, wherein the field bus links the installation components of the installations in one of a cabled or wireless data network.
